(19) United States
(12) Patent Application Publication
(10) Pub. No.: US 2008/0006962 A1
(43) Pub. Date: Jan. 10, 2008

(54) Method for manufacturing environmental protection sponge

(76) Inventor: Ya-Ming Yau, Shinju City (TW)

Correspondence Address: YA-MING YAU, 235 Chung - Ho, Box 8-24, Taipei, omitted

(21) Appl. No.: 11/481,675

(22) Filed: Jul. 7, 2006

(51) Int. Cl. B29C 67/20; C08J 5/00; B29C 71/02; B29C 37/00

(52) U.S. Cl. 264/132; 264/161; 264/233; 264/234; 264/321; 264/331.18

(57) ABSTRACT

A method for manufacturing environmental protection sponge comprises the steps of mixing material which are formed by predetermined ratios so as to form a mixing material; wherein the material contains PVA and starch; agitating and then boiling the mixing material; filling the mixing material into a mold so as to form a sponge; the sponge being taking out from the mold; washing the sponge; dewatering the sponge so as to form as environmental protection sponge; drying the environmental protection sponge; compressing the environmental protection sponge through at least one stage and then the compressed environmental protection sponge being cooled; rolling the environmental protection sponge by turning the environmental protection sponge through at least one roller so that the environmental protection sponge has a uniform structure; cutting and printing patterns on the environmental protection sponge; and packaging the shaped environmental protection sponge.

### FIELD OF THE INVENTION

The present invention relates to manufacturing of manmade sponge, and in particular to method for manufacturing environmental protection sponge comprising the steps of mixing material containing PVA and starch; agitating, boiling; filling the mixing material into a mold; washing; dewatering; drying; compressing and then cooling; rolling the environmental protection sponge; cutting and printing patterns on the environmental protection sponge; and packaging the shaped environmental protection sponge.

### BACKGROUND OF THE INVENTION

The natural sponge is a clean and water absorption material and are widely used as clean devices. However the natural sponge is expansive and thus plant fiber is used to replace the natural sponge. However the natural sponge is not so preferred as the natural sponge in cleanness and water absorption ability, but it is natural and easily combustible.

Manmade chemical sponges from fossil material are widely used because they are cheap, but this sponge has not so preferred as the natural sponge in cleanness and water absorption ability. Thereby the chemical sponge cannot be decomposed by microorganisms. In combustion, it will generate poisonous gas and it is difficult to treat the waste of the manmade chemical sponge. Therefore, it induces the problem of environment protection. However the manmade sponges are widely used due to cheapness and easy manufacture

### SUMMARY OF THE INVENTION

Accordingly, the primary object of the present invention is to provide a method for manufacturing environmental protection sponge which comprises the steps of mixing material which are formed by predetermined ratios so as to form a mixing material; wherein the material contains polyvinyl alcohol (PVA) and starch; agitating and then boiling the mixing material; filling the mixing material into a mold so as to form a sponge; the sponge being taking out from the mold; washing the mixing material; dewatering the environmental protection sponges so as to form environmental protection sponge; drying the environmental protection sponge; compressing the environmental protection sponge through at least one stage and then the compressed environmental protection sponge being cooled; rolling the environmental protection sponge by turning the environmental protection sponge through at least one roller so that the environmental protection sponge has a uniform structure; cutting and printing patterns on the environmental protection sponge to have desired shapes; and packaging the shaped environmental protection sponge in a time period not over 30 minutes; wherein if necessary, the environmental protection sponge can be compressed further before packaging step.

The various objects and advantages of the present invention will be more readily understood from the following detailed description when read in conjunction with the appended drawing.

### BRIEF DESCRIPTION OF THE DRAWINGS

FIG. 1 is a block diagram of the method for manufacturing environmental protection sponge of the present invention.

FIG. 2 is a schematic view about the drying step in the method for manufacturing environmental protection sponge of the present invention.

FIG. 3 is a schematic view about the compressing step of the method for manufacturing environmental protection sponge of the present invention.

FIG. 4 is a schematic view about the rolling step of the method for manufacturing environmental protection sponge of the present invention.

FIG. 5 is a schematic view about the cutting step of the method for manufacturing environmental protection sponge of the present invention.

FIG. 6 is a perspective view about the compressing of the method for manufacturing environmental protection sponge of the present invention.

### DETAILED DESCRIPTION OF THE INVENTION

In order that those skilled in the art can further understand the present invention, a description will be described in the following in details. However, these descriptions and the appended drawings are only used to cause those skilled in the art to understand the objects, features, and characteristics of the present invention, but not to be used to confine the scope and spirit of the present invention defined in the appended claims.

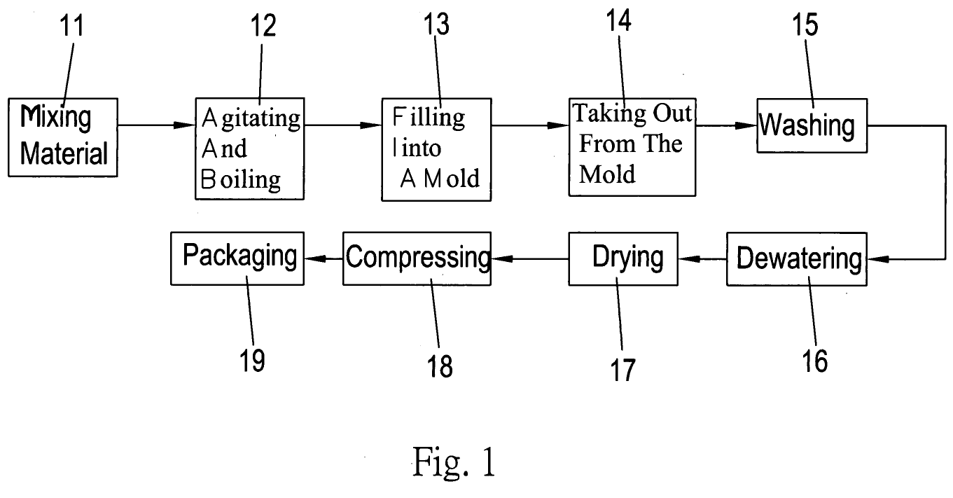

Referring to FIG. 1, the manufacturing method for environmental protection sponge is disclosed, which is clean and water-absorbed. After the environmental protection sponge is deserted, it can be decomposed by microorganisms. No poisonous gas generates after combustion.

FIG. 1 shows the block diagram of the present invention. The present invention comprise the steps of mixing material (step 11) which are formed by predetermined ratios so as to form a mixing material; wherein the material of the environmental protection sponge 2 contains PVA (polyvinyl alcohol) and starch; the PVA is nonpoisonous water-solvable high molecular material; the starch has the affect of speeding the decomposition of the PVA by microorganisms; then agitating and then boiling the mixing material; boiling the mixing material (step 12) so that the two materials are mixed uniformly; then filling the mixing material into a mold (step 13) so as to form a sponge; then the sponge being taking out from the mold (step 14); then washing the mixing material (step 15); and then dewatering the environmental protection sponges (step 16) so as to complete the process of manufacturing the environmental protection sponge 2 of the present invention and then the environmental protection sponge being dried (step 17); and then the environmental protection sponge being compressed and cut to form a desired shape (step 18); finally the shaped environmental protection sponge is packaged (step 19) for selling.

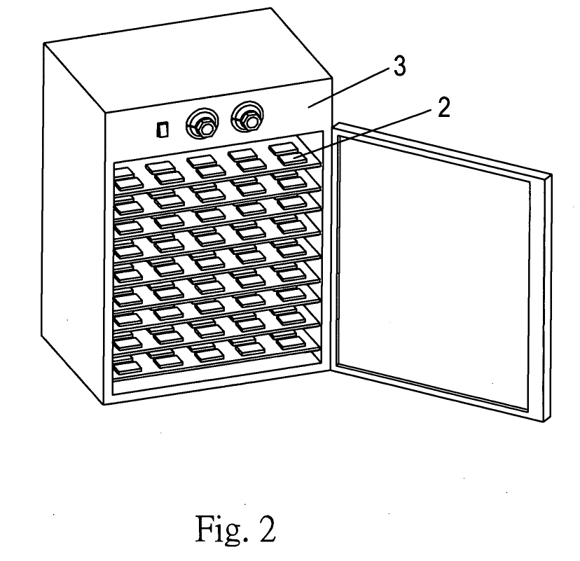

Referring to FIG. 2, a schematic view about the drying of the environmental protection sponge of the present invention is illustrated. In the process, the environmental protection sponge 2 is dried by placing the environmental protection sponge into an oven 3 with a temperature below then 70° C. for the following compressing process 18.

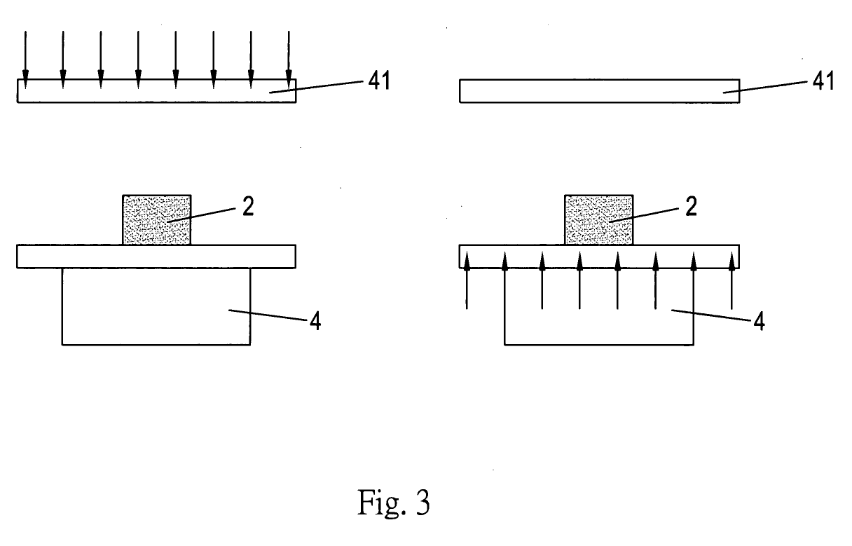

Referring to FIG. 3, the compressing process of the present invention is illustrated. In the process, the environmental protection sponge is compressed downwards or upwards. The dried environmental protection sponge 2 is placed into a compressing device 4 for the first stage compressing process. Or the environmental protection sponge 2 is compressed upwards toward a compressing plate 41 at an upper side step by step or compressed downwards toward a compressed plate 41 at the lower side step by step. The compressing process is divided into a plurality of steps. Then the environmental protection sponge 2 is cooled naturally.

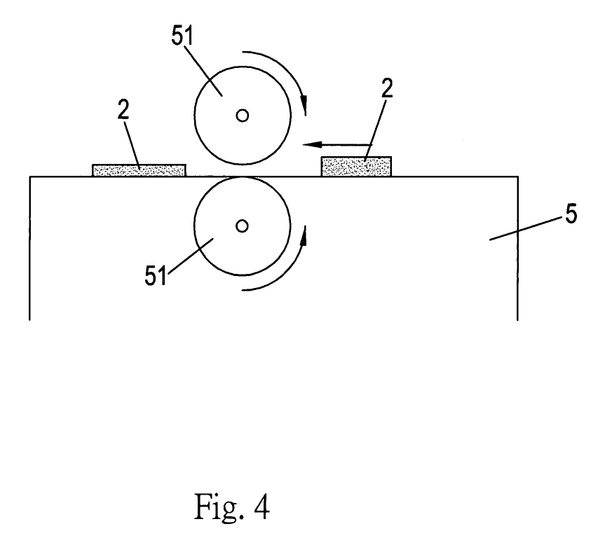

Referring to FIG. 4, the compressed environmental protection sponge 2 is placed to a rolling pressing machine 5. The rolling pressing machine 5 drives the environmental protection sponge to rollers 51 for compressing further. The environmental protection sponge 2 can be rolled many times and turned around so as to have a uniform structure.

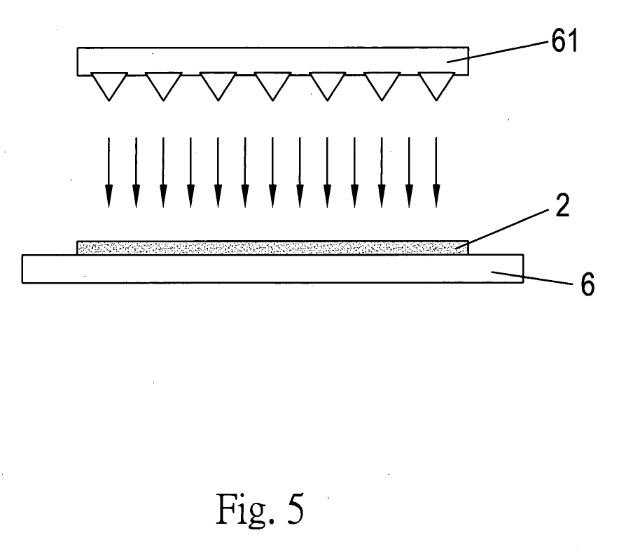

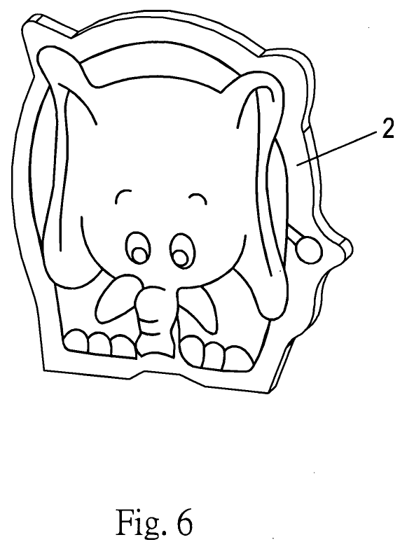

Referring to FIGS. 5 and 6, the cutting process of the present invention is illustrated. The environmental protection sponge 2 is then transferred to a cutting machine 6 for cutting by knives 61 on the cutting machine 6 so as to form a desired shape. Patterns can be printed on the environmental protection sponge 2. Then the environmental protection sponge 2 is packaged to prevent from expansion. Thereby if necessary, the environmental protection sponge can be compressed further before packaging step.

Advantages of the present invention is that the environmental protection sponge has preferred water absorption property with a ratio of 800%; the environmental protection sponge is decomposable by microorganisms; no poisonous gas generates as it is combusted; the environmental protection sponge can be compressed to have a volume of one tenth of the original size; furthermore, the environmental protection sponge can be formed as a desired shape; finally, the environmental protection sponge can be transferred and stored with a smaller volume.

Moreover in the present invention, the pressure in cutting is above 3 tons. The compressing step is performed vertically. The knife in cutting may be a wood knife.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A method for manufacturing environmental protection sponge comprising the steps of
mixing material which are formed by predetermined ratios so as to form a mixing material; wherein the material contains polyvinyl alcohol (PVA) and starch;
agitating and then boiling the mixing material;
filling the mixing material into a mold so as to form an environmental protection sponge;
taking out the sponge from the mold;
washing the sponge;
dewatering the sponge;
drying the sponge;
compressing the sponge through at least one stage and then cooling the sponge;
rolling the sponge by turning the sponge through at least one roller so that the sponge has a uniform structure;
cutting and printing patterns on the sponge to have desired shapes; and
packaging the shaped sponge in a time period not over 30 minutes;
wherein if necessary, the sponge can be compressed further before packaging step.

2. The method for manufacturing environmental protection sponge as claimed in claim 1, wherein the sponge is dried by placing the sponge into an oven with a temperature below then 70° C.

3. The method for manufacturing environmental protection sponge as claimed in claim 1, wherein the pressure in cutting is above 3 tons.

4. The method for manufacturing environmental protection sponge as claimed in claim 1, wherein the compressing step is performed vertically.

5. The method for manufacturing environmental protection sponge as claimed in claim 1, wherein in compressing step, the sponge is placed in a compressed table and then the sponge is compressed upwards or downwards.

6. The method for manufacturing environmental protection sponge as claimed in claim 1, wherein the knife in cutting is a wood knife.
